(19) United States
(12) Patent Application Publication
(10) Pub. No.: US 2005/0147191 A1
(43) Pub. Date: Jul. 7, 2005

(54) Extended frequency error correction in a wireless communication receiver

(76) Inventors: George J. Geier, Scottsdale, AZ (US); Robert M. Harbour, Gilbert, AZ (US); Thomas M. King, Tempe, AZ (US)

Correspondence Address: MOTOROLA INC, 600 NORTH US HIGHWAY 45, ROOM AS437, LIBERTYVILLE, IL, 60048-5343, US

(21) Appl. No.: 10/751,176

(22) Filed: Jan. 2, 2004

(51) Int. Cl. H04B 7/185; G01S 1/00

(52) U.S. Cl. 375/344; 375/343; 342/357.12

(57) ABSTRACT

A method (200) and apparatus (900) for correcting frequency errors of received signals in a wireless communication receiver are disclosed. The wireless communication device (900) receives (204) a signal; correlates (206) the received signal with the plurality of offset prestored data sets; generates (208) at a predetermined data rate interval a plurality of signal correlations where each of the plurality of correlations is correlated to each of the plurality of offset prestored data sets; and computes (210) a frequency error estimate based upon the plurality of signal correlations.

### FIELD OF THE INVENTION

The present invention relates generally to a wireless communication receiver and more specifically, to correcting frequency errors of received signals in a wireless communication receiver.

### BACKGROUND OF THE INVENTION

According to the Federal Communications Commission (“FCC”) cellular radiotelephone calls must be geographically locatable, which is a highly desirable feature for emergency services systems such as E911. The FCC requires stringent accuracy and availability performance objectives and demands that cellular radiotelephones must be locatable within 50 meters 67% of the time, and within 150 meters 95% of the time for handset based solutions. For network-based solutions, the FCC requires that the radiotelephone must be locatable within 100 meters 67% of the time, and within 300 meters 95% of the time. However, even for the network-based solutions, which have less stringent requirements, it has been difficult achieve the desired results using a traditional infrastructure technology method, such as time of arrival (“TOA”) and time difference of arrival (“TDOA”).

In order to include Global Positioning System (“GPS”) receivers in wireless portable communication devices such as cellular radiotelephones, performance needs to be improved in several areas, at least one such example includes weak signal detection. Users of cellular radiotelephones have become accustomed to making calls indoors, and traditional processing of GPS signals will not accommodate the attenuation caused by most buildings. Because GPS receivers capture signals transmitted from satellites at quite an extraordinary distance, any objects in the direct line of sight between the GPS receiver and the satellites often makes reception of the satellite-transmitted signals difficult due to the attenuation of the satellite-transmitted signals by interfering objects. Trees, buildings, and other high-profile objects can cause line of sight interference resulting in difficulties associated with detecting a weak or low signal.

Differential GPS approaches may be used to improve accuracy of GPS receivers. However, differential GPS approaches are complex and costly, and moreover do not address the weak signal detection difficulties issues. A GPS satellite transmits a signal which, given the transmission range, has a guaranteed signal level of only −130 dBm on the surface of the earth, and has a typical measured level of about −125 dBm on the surface of the earth. The acquisition threshold of current automotive and consumer grade handheld GPS receivers is on the order of −137 dBm, making the link margin for signal acquisition to be only about 7 to 12 dB.

A sequential detection algorithm is used by almost every GPS receiver on the market in order to acquire the spread spectrum signals of the GPS satellites. The acquisition threshold may be extended to lower levels by lengthening the pre-detection integration (“PDI”) interval at the expense of acquisition time. However, the PDI is limited to a maximum PDI of about 12 milliseconds (“msec”), which corresponds to 83 Hz bandwidth, beyond which the sequential detection process breaks down due to the GPS signal structure. The GPS signal structure includes fifty bits-per-second (“50 BPS”) navigation data, which is modulated by using a binary phase shift key (“BPSK”) method, transmitted on top of the 1.023 MHz spreading code that ultimately limits how long one can coherently integrate in order to increase the signal to noise ratio (“SNR”). Beyond 20 msec, which corresponds to one data bit time for 50 BPS, the data bit transitions cause the integration sum to be reduced or sum to zero, depending on the phase relationship of the integration period relative to the data bit transition. Further, inaccurate frequency estimate of the received GPS signal increases the satellite signal acquisition time by increasing the Doppler search space.

Navigation application, such as an application for providing directions to a local restaurant through driving instructions downloaded to a user's device in the user's vehicle using the cellular infrastructure, is becoming more popular. For such a system to operate effectively in urban canyon areas, an ability to extend the tracking thresholds below those of a conventional GPS receiver is highly desirable. Threshold reduction can generally be accomplished through improvements in the frequency error detector and/or improvements in the frequency tracking algorithm itself, for example, by relying upon the ability to measure the difference in the phase errors over time. However, as well-known in the art, differencing in time inherently “amplifies” high frequency error, and the prior art frequency error detection technique of relying upon the ability to measure the difference in the phase error over time can be expected to become increasingly more difficult as signal strength is reduced.

### BRIEF DESCRIPTION OF THE DRAWINGS

FIG. 1 is an exemplary block diagram of an environment where the present invention may be practiced;

FIG. 2 is an exemplary flowchart of a method in a wireless communication for correcting a frequency error of a received signal in accordance with the present invention;

FIG. 3 is an exemplary flowchart further describing a process of correlating the received signal with a plurality of offset prestored data sets;

FIG. 4 is an exemplary flowchart further describing a process of computing a frequency error estimate based upon the plurality of signal correlations;

FIG. 5 is an exemplary structure of I-Q correlation samples used in Doppler Curve Fitting function;

FIG. 6 is an exemplary flowchart describing a single execution of Doppler Curve Fitting function;

FIG. 7 is an exemplary graph illustrating the initial state of the Doppler Curve Fit process;

FIG. 8 is an exemplary graph illustrating the result of a single iteration of the Doppler Curve Fit process; and

FIG. 9 is an exemplary block diagram of a global positioning system receiver configured to correct a frequency error of a received signal in accordance with the present invention.

### DETAILED DESCRIPTION OF THE PREFERRED EMBODIMENTS

The present invention relates to correcting frequency errors of received signals in a wireless communication receiver. The ability to acquire signals, such as signals transmitted from satellites, at lower thresholds is extended to tracking applications in a communication device such as a cellular phone with an embedded global positioning system (“GPS”) receiver in a docking station within an automobile. Unlike prior art detectors, which rely upon the ability to measure the difference in the phase errors over time, and are known to amplify high frequency errors and to degrade sharply as the signal strength decreases, the present invention measures frequency errors directly in the frequency error domain.

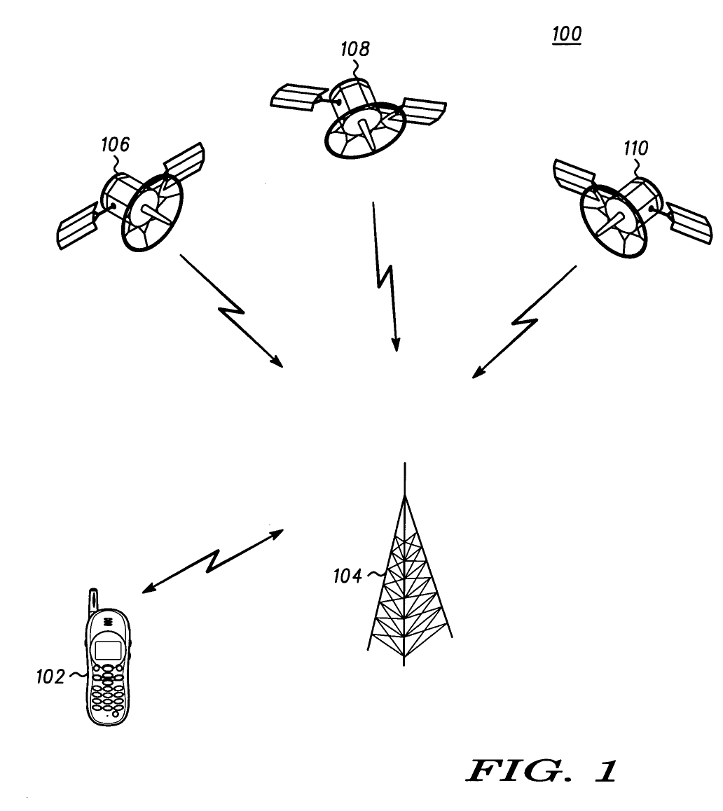

FIG. 1 is an exemplary block diagram 100 of an environment where the present invention may be practiced. A wireless communication device 102, which is equipped with a GPS receiver (not shown), is in a coverage area of a base station 106, and is also in view of three satellites 106, 108, and 110. Each of the satellites 106, 108, and 110, transmits a signal, which the wireless communication device 102 can receive.

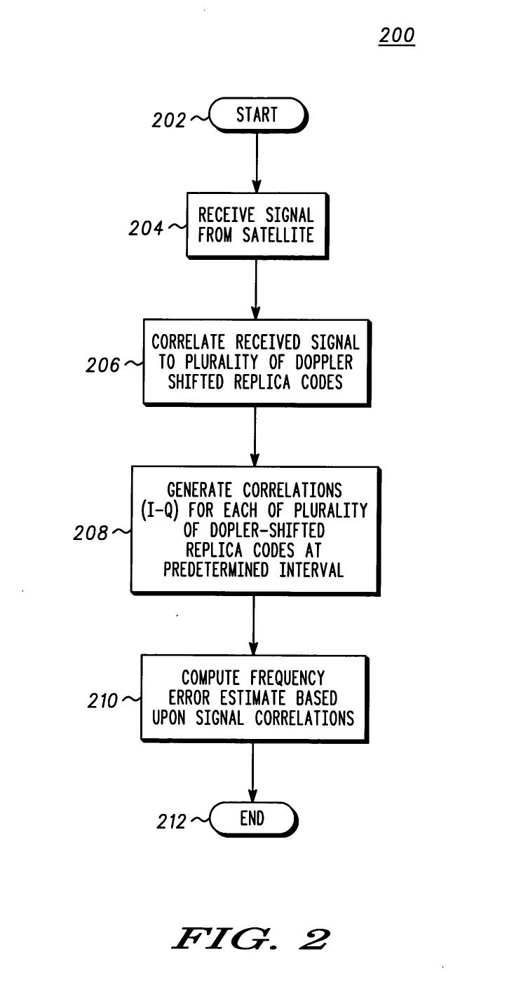

FIG. 2 is an exemplary flowchart 200 of a method in the wireless communication 102 device for correcting a frequency error of a received signal in accordance with the present invention. The process begins in block 202. In block 204, the wireless communication device 102 receives a signal transmitted from a satellite, for example a signal transmitted from the satellite 106. Then in block 206, the wireless communication device 102 correlates the received signal with a plurality of offset prestored data sets, and generates at a predetermined data rate interval a plurality of signal correlations in block 208. Each of the plurality of correlations is correlated to each of the plurality of offset prestored data sets. In block 210, the wireless communication device 102 computes a frequency error estimate based upon the plurality of signal correlations, and the process terminates in block 212.

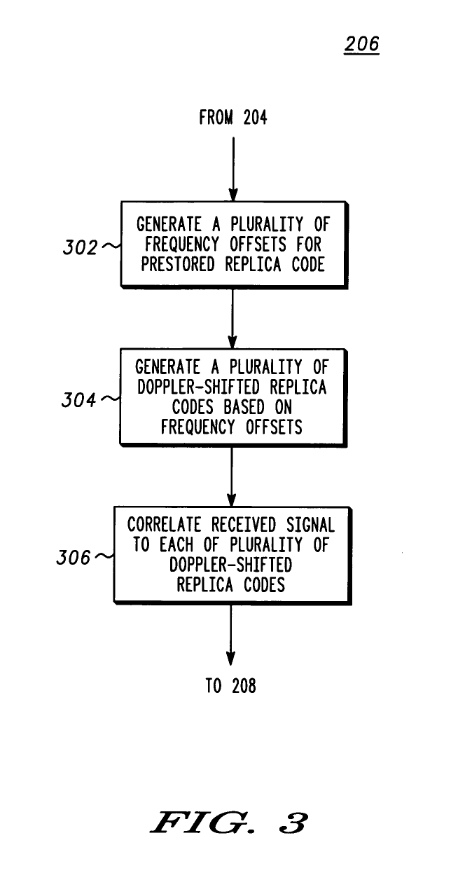

FIG. 3 is an exemplary flowchart further describing block 206 of correlating the received signal with a plurality of offset prestored data sets. In block 302, the wireless communication device 102 generates a plurality of frequency offsets for a prestored data such as a replica of a pseudo-random code transmitted from the satellite 106. For example, one set of possible frequency offsets may include −50 Hz, −25 Hz, 0 Hz, 25 Hz, and 50 Hz. Each of the frequency offsets, −50 Hz, −25 Hz, 0 Hz, 25 Hz, and 50 Hz, then is used as a Doppler shift for the replica pseudo-random code to generate a plurality of Doppler-shifted replica codes in block 304. For example, five different frequency offsets will result in five different Doppler-shifted replica codes. The wireless communication device 102 then correlates the received signal to each of the plurality of Doppler-shifted replica codes in block 306. Then in block 208, the wireless communication device 102 generates a plurality of signal correlations, such as in-phase and quadrature (“I-Q”) correlations, at a predetermined data rate interval, such as every 10 msec, every 20 msec, every 100 msec, etc., for each of the plurality of Doppler-shifted replica codes. Each I-Q pair represents the results of a coherent integration over one GPS data bit period of the 50 BPS signal.

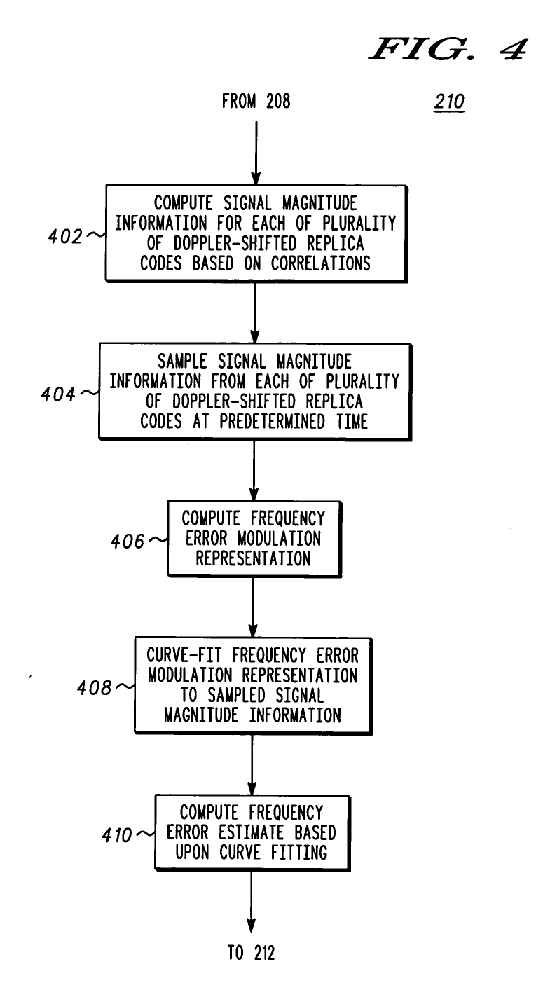

FIG. 4 is an exemplary flowchart further describing block 210 of a process of computing a frequency error estimate based upon the plurality of signal correlations. Based upon the plurality of signal correlations generated in block 208, the wireless communication device 102 computes signal magnitude information for each of the plurality of signal correlations in block 402. The wireless communication device 102 then samples the signal magnitude information from each of the plurality of signal correlations at a predetermined time in block 404, and computes a frequency error modulation representation of the received signal in block 406. It is known in the art that the frequency error modulation representation of the received signal can be expressed as |sin x/x| where x is related to a product of an integration time of the received signal and the frequency error between the received signal and the frequency used to generate the signal correlations. In block 408, the wireless communication device 102 curve-fits the computed frequency error modulation representation to the sampled signal magnitude information, and in block 410, computes a frequency error estimate based upon the curve-fitting.

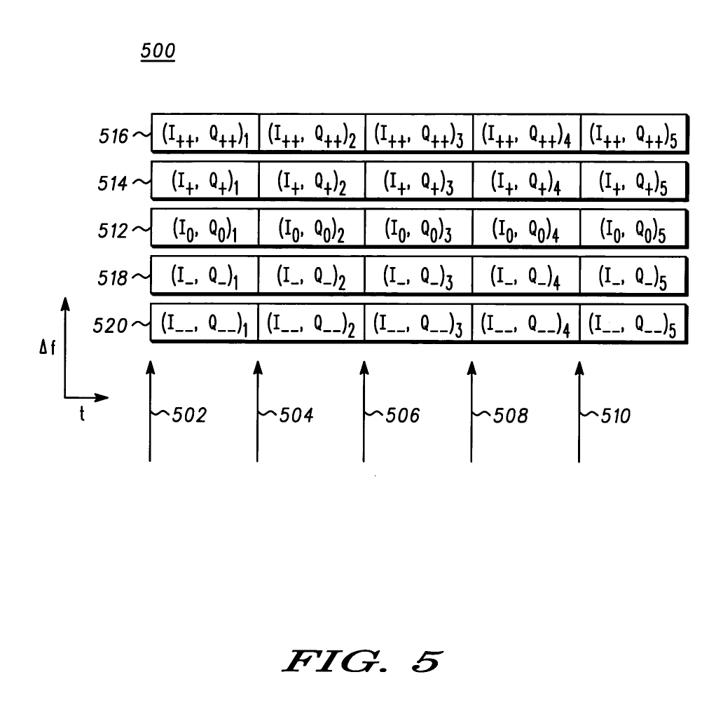

FIG. 5 is an exemplary structure 500 of the I-Q correlation samples used in the curve fitting function such as Doppler Curve Fitting (“DCF”) function. The I-Q samples are arranged in two dimensions, with the horizontal direction representing time, increasing from left to right, and the vertical direction representing frequency offsets, increasing from bottom to top. As previously discussed, each I-Q pair represents the results of a coherent integration over one GPS data bit period of the 50 BPS signal, which is 20 msec. The data bit boundaries, 502, 504, 506, 508, and 510, of the 50 BPS are aligned with the start of the Doppler-shifted replica codes, and bit synchronization can be performed as described by U.S. Pat. No. 6,532,251, the disclosure of which is incorporated herein by reference.

The notations below are used to help describe the DCF function. In this example, there are five frequency offsets, and there are five I-Q correlation samples associated with each of the five frequency offsets.
(I₀, Q₀)ᵢ, i=1, 2, 3, 4, 5 denote the I-Q correlation samples generated using the current best estimate of Doppler frequency shown as 0 Hz offset row of data 512;
(I₊, Q₊)ᵢ, i=1, 2, 3, 4, 5 denote the I-Q correlation samples generated using the current best estimate of Doppler frequency incremented by D, shown as D Hz offset row of data 514;
(I₊₊, Q₊₊)ᵢ, i =1, 2, 3, 4, 5 denote the I-Q correlation samples generated using the current best estimate of Doppler frequency incremented by 2D, shown as 2D Hz offset row of data 516;
(I₋, Q₋)ᵢ, i=1, 2, 3, 4, 5 denote the I-Q correlation samples generated using the current best estimate of Doppler frequency incremented by −D, shown as −D Hz offset row of data 518; and
(I₋₋, Q₋₋)ᵢ, i=1, 2, 3, 4, 5 denote the I-Q correlation samples generated using the current best estimate of Doppler frequency incremented by −2D, shown as −2D Hz offset row of data 520.

Inputs to the DCF function are a set of five magnitudes denoted as M₀, M₊, M₊₊, M₋, M₋₋, corresponding to the I-Q sample data, (I₀, Q₀), (I₊, Q₊), (I₊₊, Q₊₊), (I₋, Q₋), and (I₋₋, Q₋₋), respectively. More specifically, the magnitudes can be computed in one of two ways: by using a single I-Q pair sample for each magnitude, and by using a plurality of I-Q pair samples for each magnitude. For the method of using a single I-Q pair sample for computing each magnitude, the following equations may be used:
M₀ᵢ=\sqrt{I₀ᵢ²+Q₀ᵢ²} (1)
M₊ᵢ=\sqrt{I₊ᵢ²+Q₊ᵢ²} (2)
M₊₊ᵢ=\sqrt{I₊₊ᵢ²+Q₊₊ᵢ²} (3)
M₋ᵢ=\sqrt{I_{−i}²+Q_{−i}²} (4)
M₋₋ᵢ=\sqrt{I_{−−i}²+Q_{−−i}²} (5)

Note that, when a set of magnitudes is determined according to Equations (1)-(5), each magnitude set represents one of five possible sets of magnitudes, for example, M₀₁, M₀₂, M₀₃, M₀₄, and M₀₅ for Equation (1). Each of the five magnitude sets can be separately input to the DCF process, and be averaged to produce a final frequency error for the satellite of interest. Thus, the DCF process is executed five times in generating a single frequency error estimate when the magnitudes are determined according to Equations (1)-(5). Preferably, the I-Q pair samples are first accumulated noncoherently to form a set of magnitudes which only require a single execution of the DCF, as illustrated by Equations (6)-(10) below.

$$\begin{matrix}{M}_{0} = \sqrt{{\sum }_{i = 1}^{5} ( {I}_{0 i}^{2} + {Q}_{0 i}^{2} )} & ( 6 ) \\ {M}_{+} = \sqrt{{\sum }_{i = 1}^{5} ( {I}_{+ i}^{2} + {Q}_{+ i}^{2} )} & ( 7 ) \\ {M}_{++} = \sqrt{{\sum }_{i = 1}^{5} ( {I}_{++ i}^{2} + {Q}_{++ i}^{2} )} & ( 8 ) \\ {M}_{-} = \sqrt{{\sum }_{i = 1}^{5} ( {I}_{- i}^{2} + {Q}_{- i}^{2} )} & ( 9 ) \\ {M}_{--} = \sqrt{{\sum }_{i = 1}^{5} ( {I}_{-- i}^{2} + {Q}_{-- i}^{2} )} & ( 10 )\end{matrix}$$

Note that coherent accumulation of the I-Q pair samples is not possible, because carrier phase is not tracked by the DCF process. The square root operations indicated in Equations (1)-(10) are not necessary and any suitable approximations may be used to reduce the imposed computational burden.

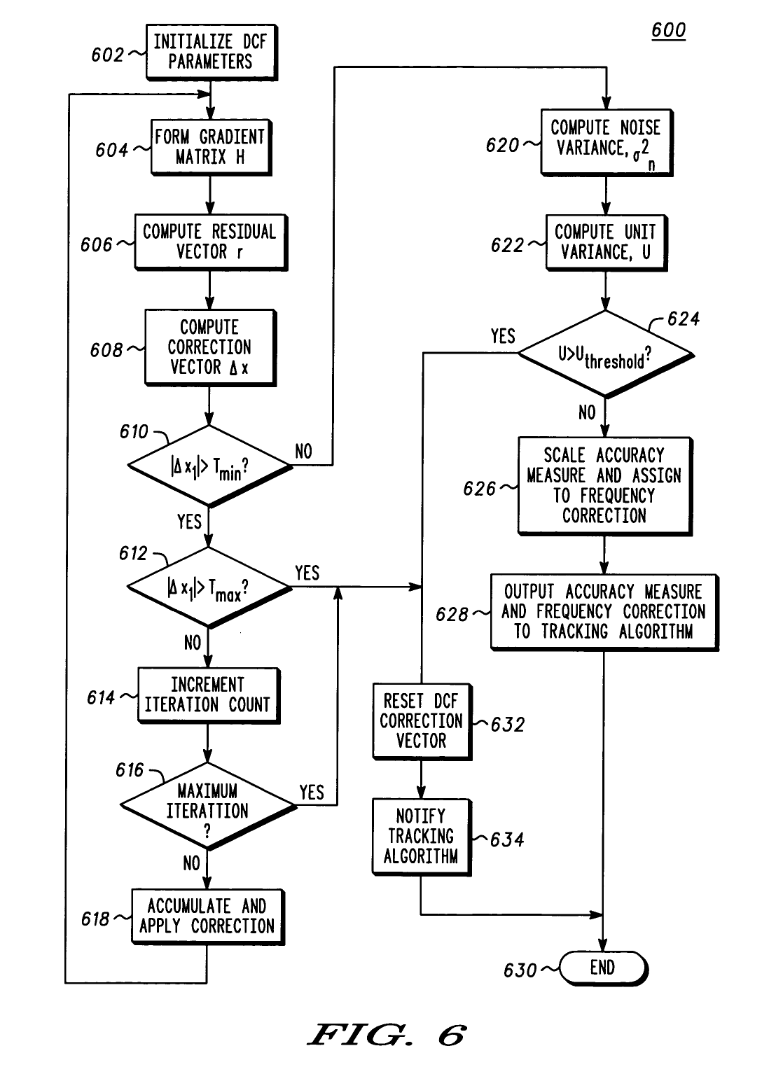

FIG. 6 is an exemplary flowchart 600 describing a single execution of DCF function. Before the single execution of DCF function begins, a test is performed to ensure that the magnitude M₀ corresponds to the approximate peak of the Doppler error modulation, i.e., the well-known |sin x/x| modulation. If M₀ is not the largest correlation magnitude, then the DCF function cannot be expected to converge because the correction of DCF is limited to one-half of the Doppler bin size, i.e., D/2. If M₀ is not the largest correlation magnitude, it is likely that frequency track on the signal has been lost, the signal was falsely acquired, or the true peak is still buried in the noise. In each case, an appropriate course of action is to accumulate the next set of data with the current set to produce a new set of magnitudes for the DCF function. After some number of accumulations, as a function of the expected frequency error dynamics, loss of frequency lock must be declared if the peak of the accumulated data is not M₀.

In block 602, the parameters of the DCF are initialized by setting the following parameters: the frequency estimate is set to the center of the frequency range, the amplitude is set to M₀, and the iteration count, frequency and amplitude corrections are set to zero. In block 604, a gradient matrix H is formed from the current set of parameters: the gradient matrix H has five rows corresponding to each of the five frequency offset estimates, Δfᵢ for i=1, , 3, 4, 5 and two columns corresponding to the frequency and amplitude corrections. Mathematically, H can be represented as:

$$H = \frac{\partial m}{\partial x} \qquad ( 11 )$$

where mᵢ=

$$M \cdot \frac{sin ( π \cdot Δ {f}_{i} \cdot T )}{( π \cdot Δ {f}_{i} \cdot t )} ,$$

and
x is a correction vector.

Bold letters in Equation (11) and following equations indicate that those terms are vectors. A residual vector r is then found by subtracting the vector of modeled magnitudes, m, from the vector of measured magnitudes, M, in block 606 as expressed in Equation (12).
r=m−M (12)

The correction vector Δx is then found as a least squares (“LS”) solution to the residual vector in block 608 as expressed in Equation (13).
Δx=(H^{T}H)⁻¹H^{T}r (13)
where: ^{T} denotes the transpose operation and ⁻¹ denotes matrix inverse.

For the single execution of DCF, the first corresponding frequency correction magnitude, the magnitude of Δx₁ from Equation (13), is then compared against a minimum threshold in block 610. If the magnitude of Δx₁ exceeds the minimum threshold in block 610, then the magnitude of Δx₁ is compared against a maximum threshold in block 612, where the maximum threshold is generally set to one-half of the bin size, which is D/2, because the true frequency is assumed to lie in the Doppler bin corresponding to the peak magnitude. If the magnitude of Δx₁ does not exceed the maximum threshold, the solution iteration count is incremented in block 614, and then the solution iteration count is compared against a maximum allowable iteration count in block 616. If the solution iteration count does not exceed the maximum allowable iteration count, then the correction vector is applied and accumulated in block 618, which includes the first component of the correction vector Δx being subtracted from the current best estimate of frequency, and the second component of the correction vector Δx being used to adjust the peak magnitude. The accumulated frequency correction will be output to a tracking algorithm upon meeting certain accuracy. Then the process repeats from block 604.

Referring back to block 610, if the magnitude of Δx₁ does not exceed the minimum threshold in block 610, then a frequency error estimate is available for possible output to the tracking algorithm, and the accuracy of the frequency error estimate is evaluated next. The accuracy of the frequency error estimate is generally a function of the signal magnitude relative to the noise level in the correlation magnitude samples. In block 620, a noise variance, which can generally be determined from the measured C/No for the satellite of interest, is computed. A statistical consistency parameter, referred to as a unit variance U is then computed in block 622. The unit variance is computed by first re-computing the residual vector r of Equation (12) using the solution determined in the final iteration of the convergence loop. The unit variance U is then:

$$U = \frac{{r}^{T} r}{4} \qquad ( 14 )$$

In block 624, whether the unit variance falls within an acceptable range is determined by comparing the unit variance against a predetermined threshold value. If the unit variance falls within an acceptable range, then the unit variance is used to scale an accuracy measure, and the accuracy measure is assigned to the frequency error estimate in block 626. Alternatively, the computed noise variance in block 620 can be used directly to assign the accuracy measure to the frequency error estimate. The predicted accuracy of the frequency error estimate is given by the following relation:

$${σ}_{Δ f}^{2} = \{ \begin{matrix}{P}_{11} & \\ U \cdot {σ}_{Δ f}^{2} & for U > 1.0\end{matrix} \qquad ( 15 )$$

where:
P₁₁ is the first diagonal element of the solution covariance matrix P;
P=(H^{T}H)⁻¹ σ²ₙ; and
σ²ₙ is the noise variance computed in block 620.
   The frequency correction and the accuracy measure are then output to the tracking algorithm in block 628, and the process terminates in block 630.

Referring back to block 624, if the unit variance falls outside of the acceptable range, then the frequency error estimate is determined to be invalid, and the correction vector Δx is set to zero in block 632. The tracking algorithm is informed in block 634 that a frequency error estimate is not available, and the process terminates in block 630. The tracking algorithm for this satellite will “coast” using a previously determined frequency error estimate until a valid frequency error estimate is generated by DCF, or loss of lock is determined. Similarly, if the magnitude of Δx₁ exceeds the maximum threshold in block 612, or if the solution iteration count exceeds the maximum allowable iteration count in block 616, then the process enters block 632, where the frequency error estimate is determined to be invalid and the correction vector Δx is set to zero.

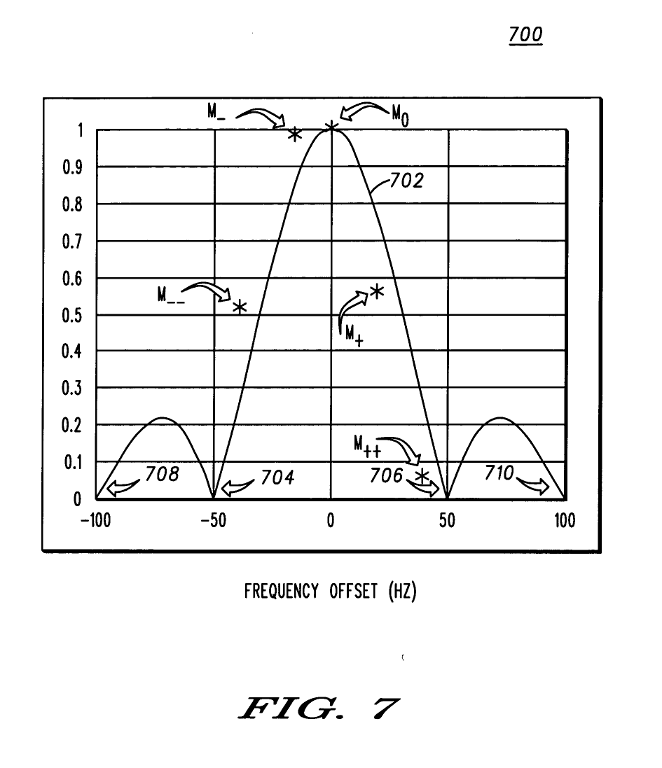

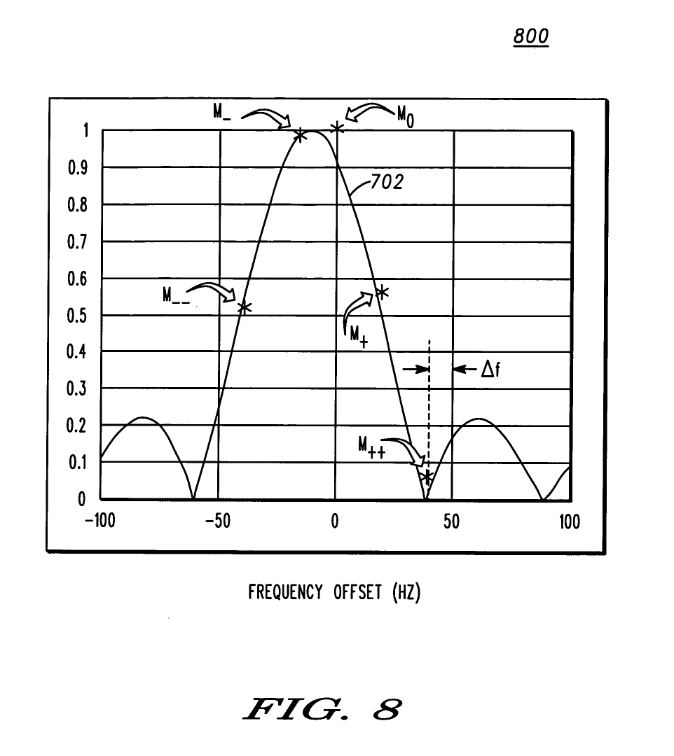

FIG. 7 is an exemplary graph 700 illustrating the initial state of the Doppler Curve Fit (“DCF”) process. The frequency error modulation graph 702 of |sin x/x|, where x corresponds to frequency in the horizontal axis, has its first set of nulls at ±50 Hz frequency offset, 704 and 706, and its second set at ±100 Hz frequency offset 708 and 710, owing to the 20 msec integration period. FIG. 7 shows that the sampled magnitudes, M₀, M₊, M₊₊, M₋, and M₋₋, do not match the profile of the frequency error modulation graph 702 profile very well. FIG. 7 also shows that the peak of the frequency error modulation graph 702 is initialized to M₀ in accordance with block 602 of FIG. 6. Because the Doppler offset D is set to 20 Hz in this example, all five sampled magnitudes fall within the main lobe of the frequency error modulation of ±50 Hz. The operation of the DCF will shift the frequency error modulation curve until it produces a “best match”, in the least-squares sense, with the five sampled magnitudes. FIG. 8 is an exemplary graph 800 illustrating the result of a single iteration of DCF. The frequency correction, denoted Δf in FIG. 8, produces an effective “left shift” of the frequency error modulation curve 702: the generally smaller differences between the frequency error modulation curve and the measured magnitudes illustrate the effectiveness of the first frequency correction. If no further adjustments to the frequency error estimate were made, the value Δf would be input to the tracking algorithm as the current frequency error estimate.

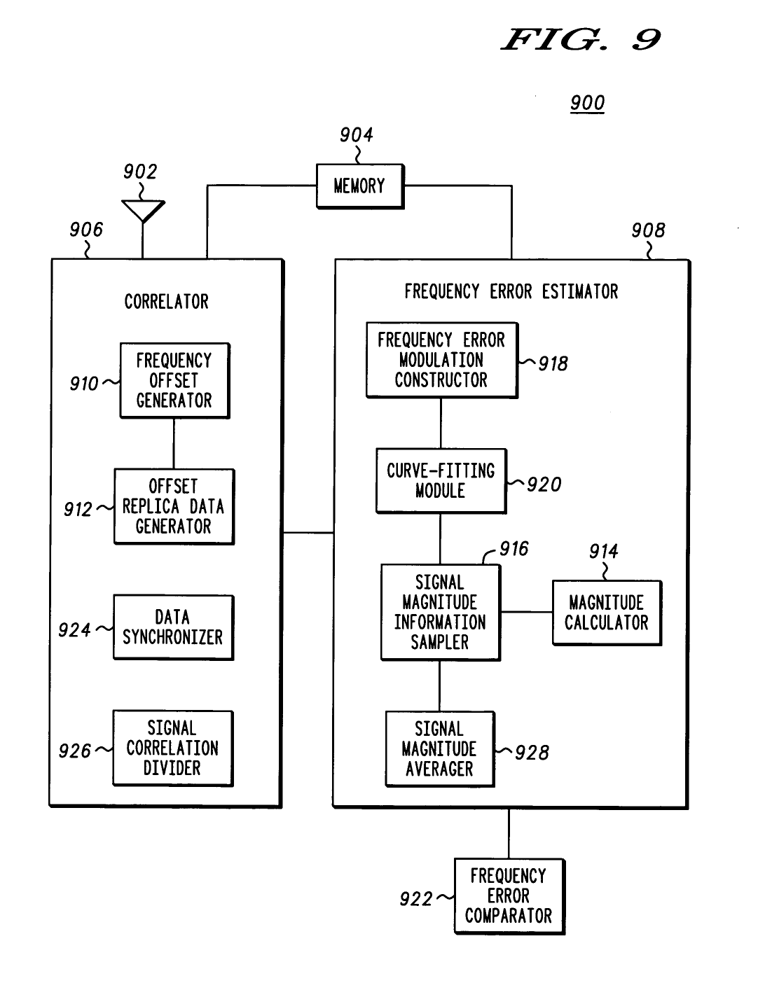

FIG. 9 is an exemplary block diagram of a global positioning system (“GPS”) receiver 900 configured to correct a frequency error of a received signal in accordance with the present invention. The GPS receiver 900 comprises an antenna 902 configured to receive a signal, and memory 904, which contains a prestored replica of the pseudo-random code and a best estimate of signal Doppler. A correlator 906, which is coupled to the antenna 902 and to the memory 904, is configured to generate at a predetermined data rate interval, such as every 100 msec, a plurality of in-phase and quadrature correlations for the received signal. A frequency error estimator 908 is coupled to the memory 904 and to the correlator 906, and is configured to compute a frequency error estimate based upon the plurality of in-phase and quadrature correlations.

The correlator 906 may further comprise a frequency offset generator 910, which is coupled to the memory 904 and is configured to generate a plurality of frequency offsets. An offset replica data generator 912 is coupled to the frequency offset generator 910, and is configured to generate a plurality of offset prestored data based upon the plurality of frequency offsets generated by the frequency offset generator 910 which are applied to the prestored replica data.

The frequency error estimator 908 may further comprise a magnitude calculator 914, which is configured to calculate magnitude information for each of the plurality of in-phase and quadrature correlations. A signal magnitude information sampler 916 may be coupled to the magnitude calculator 914, and may be configured to sample magnitude information from each of the plurality of in-phase and quadrature correlations at a predetermined time. The signal magnitude information sampler 916 may be further configured to re-sample magnitude information from each of the plurality of in-phase and quadrature correlations at a second predetermined time. A frequency error modulation constructor 918 may be also included in the frequency error estimator 908. The frequency error modulation constructor 918 may coupled to the memory 904 to construct a frequency error modulation representation of the received signal. An exemplary graph of the frequency error modulation representation has a form of |sin x/x|, which has been previously illustrated in FIG. 7. A curve-fitting module 920 may be coupled to both the signal magnitude information sampler 916 and to the frequency error modulation constructor 918, and to curve-fit the constructed frequency error modulation representation to the sampled magnitude information. The curve-fitting module 920 may be further configured to curve-fit the constructed frequency error modulation representation to the re-sampled magnitude information.

The frequency error estimator 908 may be further configured to compute the frequency error estimate based upon the curve-fitting of the constructed frequency error modulation representation to the sampled signal magnitude information and to the re-sampled signal magnitude information. A frequency error comparator 922 may be coupled to the frequency error estimator 908 to determine whether the frequency error estimate satisfies a predetermined condition such as a predetermined threshold frequency error value.

The correlator 906 further may further comprise a data synchronizer 924, which is configured to align the received signal with the plurality of offset prestored data such that the received signal and the plurality of offset prestored data can be coherently correlated. A signal correlation divider 926, which may also be included in the correlator 906, is configured to segment time-wise each of the plurality of in-phase and quadrature correlations into a predetermined number of in-phase and quadrature correlation time-segments. For example, a 100 msec in-phase and quadrature correlation may be divided into five 20 msec in-phase and quadrature correlations. The data synchronizer 924 may be further configured to align each of the predetermined number of in-phase and quadrature correlation time-segments with a corresponding time segment of the prestored data. The signal magnitude information sampler 914 may be further configured to re-sample signal magnitude information from each of the predetermined number of in-phase and quadrature correlation time-segments generated by the signal correlation divider 926. A signal magnitude averager 928, which may be coupled to the signal magnitude information sampler 916, may be configured to generate an average signal magnitude for each of the plurality of in-phase and quadrature correlations based upon the predetermined number of in-phase and quadrature correlation time-segments generated by the signal correlation divider 926. The curve-fitting module 920 may be then further configured to curve-fit the constructed frequency error modulation representation to the averaged signal magnitudes generated by the signal magnitude averager 928.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A method in a wireless communication device for correcting a frequency error of a signal, the method comprising:
receiving a signal;
correlating the received signal with a plurality of offset prestored data sets;
generating at a predetermined data rate interval a plurality of signal correlations, each of the plurality of correlations correlated to each of the plurality of offset prestored data sets; and
computing a frequency error estimate based upon the plurality of signal correlations.

2. The method of claim 1, wherein correlating the received signal with a plurality of offset prestored data sets further comprises:
generating a plurality of frequency offsets for a prestored data; and
generating the plurality of offset prestored data sets based upon the plurality of frequency offsets.

3. The method of claim 2, wherein computing a frequency error estimate based upon the plurality of signal correlations further comprises:
computing signal magnitude information for each of the plurality of signal correlations;
sampling the signal magnitude information from each of the plurality of signal correlations at a predetermined time;
computing a frequency error modulation representation of the received signal;
curve-fitting the computed frequency error modulation representation to the sampled signal magnitude information; and
computing the frequency error estimate based upon the curve-fitting.

4. The method of claim 1, wherein correlating the received signal with the plurality of offset prestored data sets coherently includes synchronizing the received signal with the prestored data at the predetermined data rate interval.

5. The method of claim 1, wherein the plurality of signal correlations are a plurality of in-phase and quadrature correlations.

6. The method of claim 1, wherein:
the wireless communication device is a global positioning system receiver, and
the plurality signal correlations are a plurality of in-phase and quadrature correlations.

7. The method of claim 3, further comprising:
determining whether the frequency error estimate satisfies a predetermined condition;
if the frequency error estimate satisfies the predetermined condition:
further correlating the received signal with a second plurality of offset prestored data sets;
further generating at the predetermined data rate interval a second plurality of signal correlations for the second plurality of offset prestored data sets; and
computing a second frequency error estimate based upon the second plurality of offset prestored data sets.

8. The method of claim 7, wherein further correlating the received signal with a second plurality of offset prestored data sets further comprises:
further generating a second plurality of frequency offsets based upon the frequency error estimate for the prestored data; and
further generating a second plurality of offset prestored data.

9. The method of claim 8, wherein computing a second frequency error estimate based upon the second plurality of offset prestored data sets further comprises:
further computing second signal magnitude information for each of the second plurality of signal correlations;
further sampling the second signal magnitude information from each of the second plurality of signal correlations at the predetermined time;
further computing a second frequency error modulation representation of the received signal;
curve-fitting the computed second frequency error modulation representation to the sampled second signal magnitude information; and
computing a second frequency error estimate based upon the curve-fitting.

10. The method of claim 7, wherein determining whether the frequency error estimate satisfies the predetermined condition by:
comparing the frequency error estimate with a predetermined allowed frequency error; and
determining the frequency error estimate satisfies the predetermined condition if the frequency error estimate is less than the predetermined allowed frequency error.

11. The method of claim 3, further comprising:
re-sampling the signal magnitude information from each of the plurality of signal correlations at a second predetermined time;
curve-fitting the computed frequency error modulation representation to the re-sampled signal magnitude information; and
re-computing a frequency error estimate based upon the curve-fitting of the computed frequency error modulation representation to the sampled signal magnitude information and to the re-sampled signal magnitude information.

12. The method of claim 3, further comprising:
segmenting time-wise each of the plurality of signal correlations into a predetermined number of signal correlation time-segments;
re-sampling the signal magnitude information from each signal correlation time-segment of the plurality of signal correlations;
generating an average signal magnitude for each frequency offset based upon the re-sampled signal magnitude information for the frequency offset; and
curve-fitting the computed frequency error modulation representation to the averaged signal magnitude information.

13. The method of claim 12, further comprising:
aligning each signal correlation time-segment with a corresponding time segment of the prestored data.

14. A global positioning system receiver configured to correct a frequency error of a received signal that includes a fifty-bits-per-second navigation data, the global positioning system receiver having a prestored replica data of a pseudo-random code in memory, the global positioning system receiver comprising:
an antenna configured to receive a signal;
a correlator coupled to the antenna and to the memory, the correlator configured to generate at a predetermined data rate interval a plurality of in-phase and quadrature correlations for the received signal; and
a frequency error estimator coupled to the correlator, the frequency error estimator configured to compute a frequency error estimate based upon the plurality of in-phase and quadrature correlations.

15. The global positioning system receiver of claim 14, wherein the correlator further comprises:
a frequency offset generator coupled to the memory, the frequency offset generator configured to generate a plurality of frequency offsets; and
an offset replica data generator coupled to the frequency offset generator, the offset replica data generator configured to generate a plurality of offset prestored data based upon the plurality of frequency offsets applied to the prestored replica data.

16. The global positioning system receiver of claim 14, wherein the frequency error estimator further comprises:
a magnitude calculator configured to calculate magnitude information for each of the plurality of in-phase and quadrature correlations;
a signal magnitude information sampler coupled to the magnitude calculator, the signal magnitude information sampler configured to sample magnitude information from each of the plurality of in-phase and quadrature correlations at a predetermined time;
a frequency error modulation constructor coupled to the memory, the frequency error modulation constructor configured to construct a frequency error modulation representation of the received signal; and
a curve-fitting module coupled to the signal magnitude information sampler and to the frequency error modulation constructor, the curve-fitting module configured to curve-fit the constructed frequency error modulation representation to the sampled magnitude information.

17. The global positioning system receiver of claim 14, further comprising a data synchronizer coupled to the correlator, the data synchronizer configured to align the received signal with the plurality of offset prestored data sets.

18. The global positioning system receiver of claim 14, further comprising:
a frequency error comparator coupled to the frequency error estimator, the frequency error comparator configured to determine whether the frequency error estimate satisfies a predetermined condition.

19. The global positioning system receiver of claim 18, wherein the predetermined condition is based upon a threshold frequency error value.

20. The global positioning system receiver of claim 16, wherein:
the signal magnitude information sampler is further configured to re-sample magnitude information from each of the plurality of in-phase and quadrature correlations at a second predetermined time,
the curve-fitting module is further configured to curve-fit the constructed frequency error modulation representation to the re-sampled magnitude information, and
the frequency error estimator is further configured to compute the frequency error estimate based upon the curve-fitting of the constructed frequency error modulation representation to the sampled signal magnitude information and to the re-sampled signal magnitude information.

21. The global positioning system receiver of claim 16, further comprising:
a signal correlation divider coupled to correlator, the signal correlation divider configured to segment time-wise each of the plurality of in-phase and quadrature correlations into a predetermined number of in-phase and quadrature correlation time-segments; and
a signal magnitude averager coupled to the signal magnitude information sampler, the signal magnitude averager configured to generate an average signal magnitude for each of the plurality of in-phase and quadrature correlations based upon the predetermined number of in-phase and quadrature correlation time-segments;
wherein the signal magnitude information sampler is further configured to re-sample signal magnitude information from each of the predetermined number of in-phase and quadrature correlation time-segments, and
the curve-fitting module is further configured to curve-fit the constructed frequency error modulation representation to the averaged signal magnitudes.

22. The global positioning system receiver of claim 21, wherein each of the predetermined number of in-phase and quadrature correlation time-segments is aligned with a corresponding time segment of the prestored data.
